(19) United States
(12) Patent Application Publication
(10) Pub. No.: US 2025/0381590 A1
(43) Pub. Date: Dec. 18, 2025

(54) PORTABLE ELECTRIC KNOCKOUT PUNCH

(71) Applicant: BLACK & DECKER INC., New Britain, CT (US)

(72) Inventors: Tobias HEEP, Idstein (DE); Kevin BHIKADIYA, Idstein (DE); Yasar AKBABA, Idstein (DE); Benjamin SCHMIDT, Idstein (DE); Arthur LAUER, Idstein (DE)

(21) Appl. No.: 18/892,748

(22) Filed: Sep. 23, 2024

(30) Foreign Application Priority Data
Jun. 13, 2024 (GB) 2408450.1
Aug. 22, 2024 (EP) 24196011.1

(51) Int. Cl. B21D 28/26

(52) U.S. Cl. CPC B21D 28/26

(57) ABSTRACT

A portable electric knockout punch for forming a hole in sheet metal including an electric motor having a motor output shaft, a hole forming mechanism having a support portion for cooperating with a die and a punch portion for cooperating with a stamp and which is operatively coupled to the motor output shaft via a transmission of the tool which in use causes linear relative movement between the punch portion and the support portion for forming a hole in sheet metal in use, the transmission including a conversion mechanism for converting torque into a linear force for causing the linear relative movement between the punch portion and the support portion.

### CROSS-REFERENCE TO RELATED APPLICATIONS

This application claims priority from GB Patent Application No. 2408450.1, filed Jun. 13, 2024 and EP patent application Ser. No. 24/196,011.1, filed Aug. 22, 2024, the disclosures of which is incorporated herein by reference in their entirety.

### FIELD OF THE INVENTION

This specification relates to a portable electric knockout punch for creating holes in sheet metal.

### BACKGROUND OF THE INVENTION

During sheet metal working it is sometimes necessary to form circular holes with specific dimensions to a high degree of precision. Hydraulic knockout punches are known for such purpose which draw a stamp located on one side of a sheet metal piece towards and subsequently into a die located on the other side of the sheet metal piece. The hydraulic nature of such tools makes them heavy and subject to high maintenance requirements. Also, in order for such hydraulic knockout punches to feel balanced in a user's hand, the manufacturer needs to carefully consider the arrangement of features within the tool housing relative to the handle. Due to space limitations within the tool housing there is some play off between arranging internal features of the tool so that the tool works vs. arranging such features so that weight distribution of the tool is optimised. Unfortunately, though due to the complex nature of hydraulic mechanisms there is not a lot of scope for rearranging internal features of the tool so that weight distribution is optimised.

### BRIEF SUMMARY OF THE INVENTION

According to the invention there is provided a portable electric knockout punch according to claim 1, wherein optional features thereof are defined in claims 2 to 12.

### BRIEF DESCRIPTION OF THE DRAWINGS

Various aspects and embodiments of the invention will now be described by way of non-limiting example with reference to the accompanying drawings, in which:

FIG. 1 illustrates a side view of a portable electric knockout punch.

FIG. 2 illustrates a die and stamp for use with the portable electric knockout punch of FIG. 1.

FIGS. 3 to 7 illustrate the portable electric knockout punch of FIG. 1 at various stages during a hole forming operation.

FIG. 8 is a cross-sectional view of the portable electric knockout punch in FIG. 1.

FIG. 9 is a cross-sectional view through the portable electric knockout punch in FIG. 8 through the axis A-A.

FIG. 10 is a cross-sectional view through the portable electric knockout punch in FIG. 8 through the axis B-B.

FIG. 11 illustrates another embodiment of the portable electric knockout punch.

FIG. 12 illustrates a cross-sectional view of the tool in FIG. 11 through the axis A-A.

### DETAILED DESCRIPTION OF THE PREFERRED EMBODIMENT

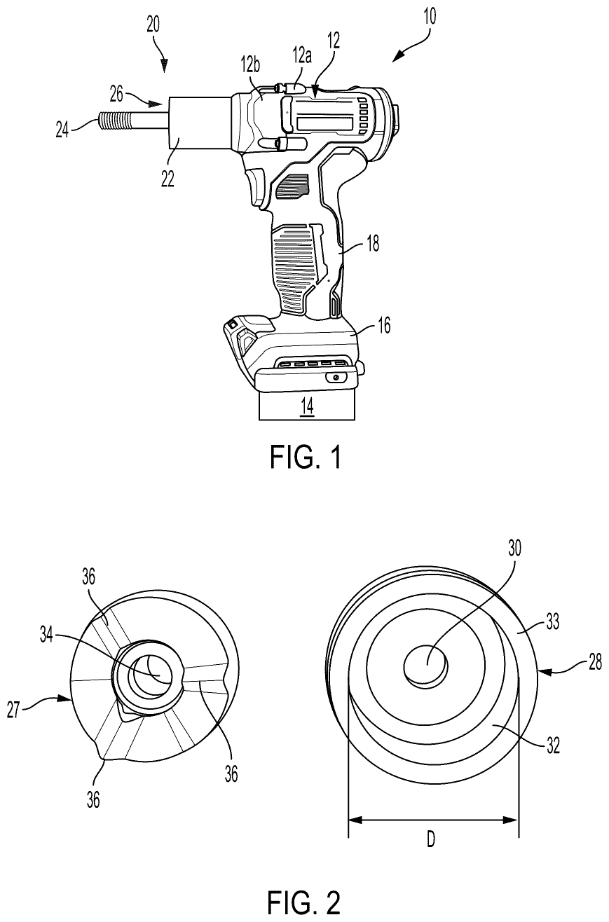

FIG. 1 shows a side cross-sectional view of a portable electric knockout punch 10. The tool 10 has a housing 12 part of which is formed of a plastic clam shell type construction 12a having two halves which are fastened together. A battery 14 is releasably connected to the base 16 of the handle 18 via a battery attachment feature. The tool 10 has a hole forming work member or hole forming mechanism 20 for forming a hole in sheet metal. A support portion 22 of the hole forming mechanism 20 is fixed relative to the tool housing 12, specifically to a metal part 12b of the housing 12. The support portion 22 defines an opening through itself and thus has an annular support surface 26 which faces away from the portable electric knockout punch 10 to the left in FIG. 1. A punch portion 24 of the hole forming mechanism 20 is moveable relative to the tool housing 12. The punch portion 24 is rod-like in shape and extends through the opening defined by the support portion 22. A distal end of the rod-like punch portion 24 is threaded in order to threadably engage with a stamp 27.

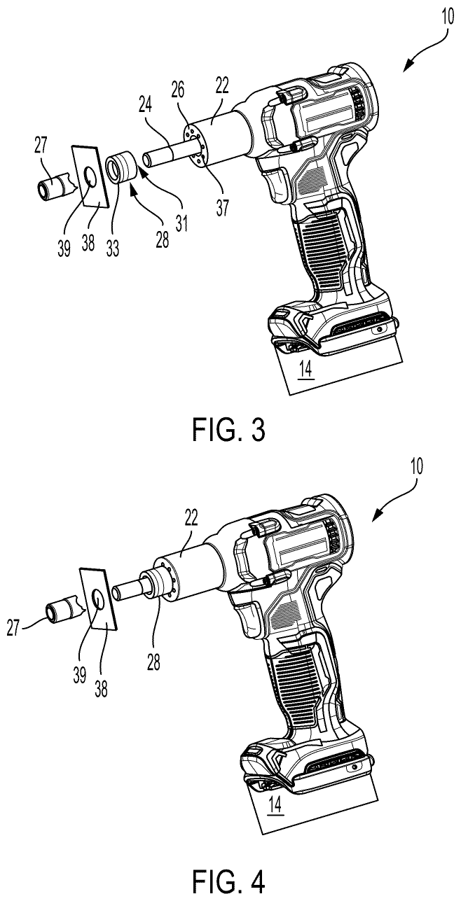

FIG. 2 shows a die 28 and stamp 27 suitable for use with the portable electric knockout punch 10. Together stamp 27 and die 28 form a hole forming assembly. With additional reference to FIG. 3 the die 28 is essentially cylindrical. One end of the die 28 defines a first opening 30 and thus first annular surface 31, the first opening 30 being configured to form a snug fit with the punch portion 24. The other end of the die 28 defines a second opening 32 of diameter D and thus second annular surface 33, the second opening 32 being configured to form a snug fit with the outer periphery of the stamp 27 as the stamp 27 is drawn into the die 28 in use. The stamp 27 is also essentially cylindrical and defines a threaded opening 34 for engaging the threaded part of the punch portion 24 and a plurality of pointed projections 36 are circumferentially arranged around the threaded opening 34 for facing towards the portable electric knockout punch 10 to the right in FIG. 1 in use.

How a hole is formed in a piece of sheet metal 38 using the portable electric knockout punch 10 will now be described with reference to FIGS. 3 to 7.

First, a die 28 is selected having a second opening 32 (the wide end) which defines a circle of the diameter D required to be formed in a piece of sheet metal. The first opening 30 (the narrow end) of the die 28 is provided around the punch portion 24 of the portable electric knockout punch 10, whereby the die 28 is slid along the length of the punch portion 24 until the die 28 engages the annular support surface 26 of the support portion 22 as illustrated in FIG. 4. To reduce the risk of the die 28 accidentally falling off the portable electric knockout punch 10 at least one magnet is provided for maintaining the die 28 in connection with the annular support surface 26, namely a plurality of magnets 37 are embedded within cavities circumferentially arranged around the annular support surface 26; however the use of one or more magnets for such purpose can be omitted for cost savings as will be appreciated.

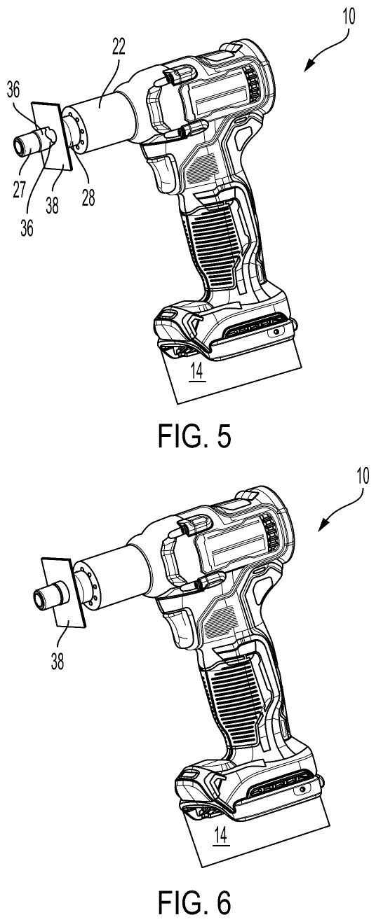

A guide hole 39 is formed in the sheet metal 38 to be worked on (e.g. using a drill or other tool), wherein persons skilled in the art will appreciate that the guide hole 39 should be wide enough to receive the punch portion 24 of the portable electric knockout punch 10 but should be smaller than the hole intended to be formed using the portable electric knockout punch 10; in otherwards the guide hole 39 should have a diameter smaller than the diameter D of the second opening 32 of the die 28 loaded on the portable electric knockout punch 10. One or both of the sheet metal 38 to be worked on and the portable electric knockout punch 10 are moved such that the punch portion 24 is caused to extend through the guide hole 39, wherein subsequently the stamp 27 is threaded onto the punch portion 24 with the circumferentially arranged pointed projections 36 facing towards the sheet metal 38 to be worked on as illustrated in FIG. 5.

A user then pulls the trigger 19 of the portable electric knockout punch 10 which causes the punch portion 24 to move axially such that it is drawn into the tool 10 through the support portion 22. As this is occurring the stamp 27 is pulled with increasing force against the sheet metal 38 to be worked on and eventually it punches through the sheet metal 38 and begins to be drawn into the die 28 wherein the outer periphery of the stamp 27 slides against the inner cylindrical surface of the die 28 as illustrated in FIG. 6.

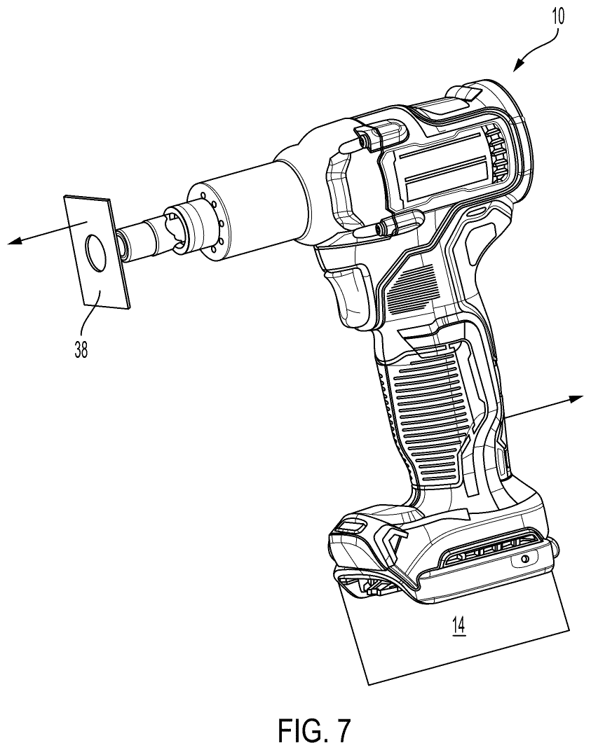

Finally, one or both of the sheet metal 38 and the portable electric knockout punch 10 are moved such that the tool 10 is removed from the hole punched in the sheet metal 38 thereby leaving a circular hole in the sheet metal 38 having a diameter substantially similar to the diameter D of the second opening 32 of the die 28 as illustrated in FIG. 7.

If a user needs to punch a circular hole having a different diameter D then a different die 28 is instead loaded on the portable electric knockout punch 10 having a second opening 32 of diameter D2. Furthermore a different stamp 27 is used, namely one having an outer periphery configured to form a snug fit with the inner cylindrical surface of the die 28 as the stamp 27 is drawn into the second opening 32 of diameter D2. Persons skilled in the art will appreciate that a set of multiple dies 28 and corresponding stamps 27 can be provided for enabling a user to selectively punch circular holes of different diameters in sheet metal.

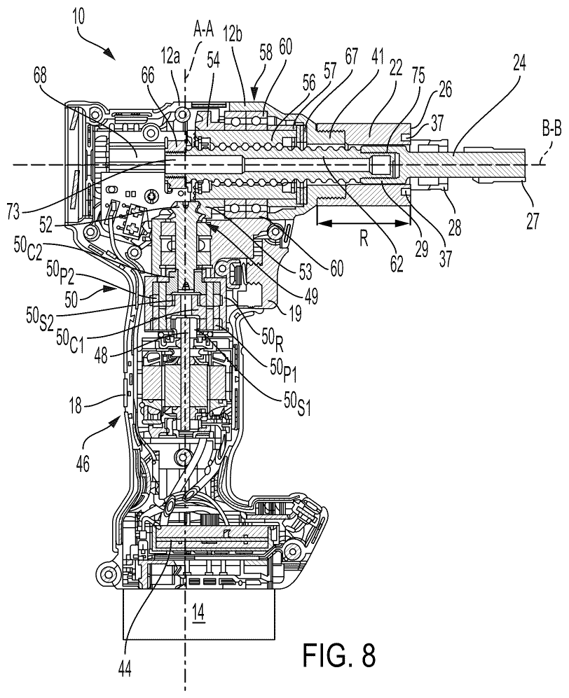

Internal features of the portable electric knockout punch 10 will now be described with reference to FIG. 8 which shows a side cross-sectional view of such power tool.

The power tool 10 has a controller 44 for determining that the trigger 19 has been pulled. In response to the controller 44 determining that the trigger 19 has been pulled the controller 44 generates a signal to activate an electric motor 46, which is a DC brushless motor. Persons skilled in the art will be able to select a suitable electric motor, however, an example of a suitable electric motor 46 is the BL41 DC brushless motor designed by Stanley Black & Decker Inc. and used in some commercially available DEWALT® branded power tools. The motor 46 is located in the handle 18 and has a motor output shaft 48.

Torque from the motor output shaft 48 is transferred via a transmission 50 to an input pinion 52 of a bevel gear arrangement 49. The transmission 50 comprises at least one planetary gear arrangement for reducing output speed while increasing torque. The motor output shaft 48 drives an input sun gear 50s1 of the first stage of the transmission 50. The input sun gear 50s1 meshes with a plurality of first stage planet gears 50p1 which mesh with a stationary outer ring gear 50R and are coupled to a first stage carrier 50c1. An axial extension of the first stage carrier 50c is the input sun gear 50s2 of the second stage of the transmission 50. The input sun gear 50s2 meshes with a plurality of second stage planet gears 50p2 which mesh with the stationary outer ring gear 50R and are coupled to a second stage carrier 50c2. An axial extension of the second stage carrier 50c2 is rotationally fixed to the input pinion 52 of the bevel gear arrangement.

The input pinion 52 of the bevel gear arrangement 49 thus rotates at a lower speed than the motor output shaft 48 however with an increased torque relative to the motor output shaft 48.

The motor output shaft 48, transmission 50 and input pinion 52 of the bevel gear arrangement 49 are aligned along a first axis A-A which extends along a longitudinal length of the handle 18. By also locating the battery attachment feature (and thus battery 14) on the first longitudinal axis A-A weight distribution of the portable electric knockout punch 10 is improved, whereby the power tool 10 feels balanced in a user's hand.

By locating the motor 46, the transmission 50 and the battery 14 on the same axis A-A extending along the length of the handle 18 improves weight distribution of internal features of the tool 10. Also, by providing the motor 40 within the handle 18 leaves more space available within the tool housing 12 above the handle 18, whereby there is more freedom to position features of the tool 10 in positions which improve weight distribution of internal features of the tool 10.

It will be appreciated that there is some design freedom in the transmission 50 between the motor output shaft 48 and the input pinion 52 of the bevel gear arrangement 49. In particular the number of planetary gear stages, and its (or their) configuration, forming the transmission 50 depends on the required gear ratio to be achieved between the motor output shaft 48 and the input pinion 52.

Given that it is well known that planetary gear stages step down rotation speed while stepping up torque persons skilled in the art, based on the disclosure given herein, will be able to decide upon a suitable transmission arrangement which achieves the required gear ratio for their tool to function; wherein the appropriate gear ratio depends on multiple factors including maximum achievable motor output torque, pitch of the ball screw arrangement described below, friction between moveable features within the tool 10 and the maximum permissible pulling force (such as up to 100 kN). It will be appreciated that for some tools 10 a suitable transmission 50 may only have a single planetary gear stage, whereas for other tools a suitable transmission 50 may have a plurality of planetary gear stages arranged in series.

Continuing with reference to FIG. 8 a bevel gear 53 of the bevel gear arrangement 49, which is meshed with the input pinion 52 for receiving torque therefrom, is provided. An axial extension of the bevel gear 53, hereafter the driving sleeve 54, is rotationally fixed relative to an input sleeve 56 of a ball screw arrangement 58. The driving sleeve 54 and input sleeve 56 are fixed relative to each other due to a friction fit arrangement. An internal surface of the input sleeve 56 comprises a threaded surface. The outer surface of the input sleeve 56 is supported by bearings 60 which enable rotation of the input sleeve 56 with respect to the housing 12. In a radial direction the bearings 60 are located between the input sleeve 56 and the inner surface of the metal part 12b of the housing 12, whereas in an axial direction the bearings 60 are located between the driving sleeve 54 and a bearing engagement sleeve 57 which is rotatably fixed to the input sleeve 56 via a friction fit engagement; part of the bearing engagement sleeve 57 lips around the outer edge of an axial bearing 67 for preventing the axial bearing 67 from touching the inner side of the metal part 12b of the housing 12. A threaded rod 62 is mounted within the input sleeve 56, which extends through the input sleeve 56. A plurality of balls, such as metal ball bearings, ride in the opposing threaded surfaces of the input sleeve 56 and threaded rod 62, thereby defining a ball screw arrangement 58.

When the input sleeve 56 is rotatably driven by the driving sleeve 54 this causes axial movement of the threaded rod 62. In other words, torque from the electric motor 46 is transferred through the transmission 50, through the bevel gear arrangement 49 to the input sleeve 56, whereby rotation thereof causes axial movement of the threaded rod 62. The threaded rod 62 is configured to move along a second longitudinal axis B-B of the tool 10. The threaded rod 62 can move forwards or backwards along the axis B-B depending on the motor driving direction, whereby the punch portion 24 moves with the threaded rod 62.

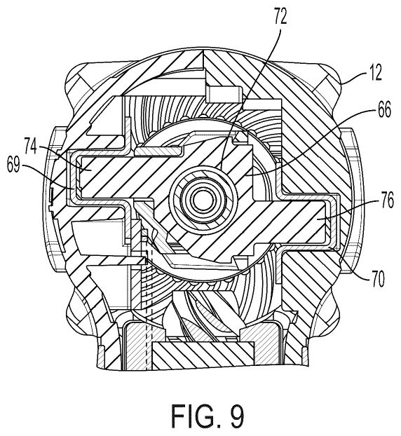

FIG. 9 shows that an anti-rotation bar 66 is engaged with the threaded rod 62 in a manner whereby the anti-rotation bar 66 is axially and rotationally fixed to the threaded rod 62. As the input sleeve 56 is rotated the anti-rotation bar 66 cooperates with the threaded rod 62 and slots 69, 70 within the housing 12 for causing the threaded rod 62 to move axially along the axis B-B. The anti-rotation bar 66 is rotationally fixed with respect to the housing 12 so it slides relative to the housing 12 through the slots 69, 70 during axial movement of the threaded rod 62.

The anti-rotation bar 66 comprises a central hole 72 with a threaded inner surface which is tightly threadably engaged with a reciprocal threaded portion 73 at an end of the threaded rod 62 as shown in FIG. 8.

The anti-rotation bar 66 comprises a first arm 74 and a second arm 76. The first and second arms 74, 76 are mounted in first and second slots 69, 70 within the housing 12. When the threaded rod 62 moves along the second longitudinal axis B-B, the first and second arms 74, 76 slide along the first and second slots 69, 70. The first and second slots 69, 70 extend along longitudinal axes which are parallel to the second longitudinal axis B-B.

With continued reference to FIG. 8 the rod-like punch portion 24 is fixed to the threaded rod 62 by a threaded connection. The proximal end of the punch portion 24 is a section of expanded diameter relative to the rest of the punch portion 24 (hereafter the expanded section 29) and which defines a cylindrical cavity having a threaded surface which is threaded onto a reciprocal threaded portion 75 at an end of the threaded rod 62 as shown in FIG. 8. When the rod-like punch portion 24 is in threaded engagement with the reciprocal threaded portion 75 of the threaded rod 62, both the punch portion 24 and threaded rod 62 extend along the second longitudinal axis B-B.

With continued referenced to FIG. 8 the metal housing part 12b defines a lip 41 having an outer threaded surface which forms a threaded connection with the heretofore described support portion 22. The support portion 22 is configured such that when it is threaded onto the lip 41 of the metal housing part 12b inner surfaces of the support portion 22 and lip 41 align and cooperate to define circular opening of continuous diameter at the junction between the support portion 22 and the lip 41, such opening having a length R. The expanded section 29 of the punch portion 24 has an outer diameter substantially similar to the diameter of the opening extending through the support portion 22 and the lip 41, whereby the range of freedom of movement of the punch portion 24 in use is defined by the length R as shown in FIG. 8. Providing that the expanded section 29 has a diameter substantially similar to the opening within the range denoted by the length R, whereby the expanded section 29 slides along the inner surface of such opening in use, provides that the risk of dirt entering the internal of the tool 10 is reduced and therefore that the reliability of the tool 10 is improved.

A volume 68 is provided within the housing 12 for accommodating the threaded rod 62 when retracted into the tool 10 during a knock out punching operation in use.

Designers are free to select a suitable way for the controller 44 to control operation of the motor 46 in use to implement a hole forming operation. In other words, designers are free to select a suitable way for the controller 44 to determine when the hole forming mechanism 20 has been actuated sufficiently for a hole to have been formed in some sheet metal 38, in other words designers are free to select a suitable way for the controller 44 to determine when the punch portion 24 has been moved far enough linearly to have punched a hole in sheet metal.

For example, in a starting configuration of the portable electric knockout punch 10 shown in FIG. 5, a piece of sheet metal 38 is about to be punched; in other words a die 28 and stamp 27 are loaded on the tool 10 on either side of the sheet metal 38 as already described. In this starting configuration the punch portion 24 is located in a home position, which is a predetermined starting position along the second longitudinal axis B-B relative to the support portion 22. Upon the controller 44 determining that the trigger 19 is pulled the controller 44 causes the electric motor 46 to rotate in a forward rotational direction for causing the punch portion 24 to be linearly moved along the second longitudinal axis B-B towards the support portion 22 whereby the stamp 27 is moved towards and eventually into the die 28. In some embodiments users are required to manually judge when a hole has been punched through the sheet metal 38 and thus are required to release the trigger 19 when the stamp 27 has punched through the sheet metal 38 and is received in the die 28, wherein upon the controller 44 detecting that the trigger 19 is released it causes the motor 46 to drive in a reverse direction for causing the punch portion 24 to be returned to its home position.

As a safety mechanism a mechanical switch may be provided within the power tool 10 for causing a reset operation upon the threaded rod 62 becoming retracted into the tool 10 by a predetermined amount. During a hole forming stage of operation the threaded rod 62 is retracted into the tool 10. If the user does not release the trigger 19 eventually an arm 74, 76 of the anti-rotation bar 66 will engage a mechanical switch, whereby upon the controller 44 detecting that the mechanical switch is activated it causes the motor 46 to reverse direction and returns the punch portion 24 to the home position; a user must then release the trigger 19 before a subsequent hole forming operation can be implemented. In some embodiments instead of a mechanical switch an optical sensor can be used for detecting the presence of the anti-rotation bar 66 or threaded rod 62 for initiating a reset operation. Furthermore, in some embodiments a magnetic sensor is provided for detecting the presence of a magnet carried by the anti-rotation bar 66 for initiating a reset operation.

Alternatively in some embodiments the controller 44 is configured to receive user input via a user interface of the tool 10 which is indicative of the thickness of the sheet metal 38 to be punched through, wherein based on this user input the controller 44 determines the extent to which the punch portion 24 should be retracted upon pulling the trigger 19. During a hole forming operation, while the trigger 19 remains pulled the controller 44 will cause enough movement of the punch portion 24 for punching a hole through the sheet metal 38 and then will reverse motor direction and return the punch portion 24 to the home position, whereby the trigger 19 must be released before a subsequent hole forming operation can be performed. At any time during a hole forming operation if the trigger 19 is released the controller 44 will cause reverse movement of the motor 46 and will return the punch portion 24 to the home position.

Moreover, designers are free to select a suitable way for the controller 44 to control operation of the motor 46 to implement a reset operation. In other words designers are free to select a suitable way for the controller 44 to determine when the punch portion 24 has returned to the home position at which point in time reverse movement of the punch portion 24 is ceased. For example a mechanical switch may be provided within the tool 10. Following a hole forming operation, upon initiation of reverse movement of the motor 46 for causing a reset operation, the controller 44 is configured to detect output from the mechanical switch indicative that an arm 74, 76 of the anti-rotation bar 66 actuates the mechanical switch, thereby indicating that the punch portion 24 has returned to the home position. Alternatively an optical sensor may be provided within the tool 10 which generates output based on the presence or absence of the anti-rotation bar 66 or threaded rod 62 wherein based on output from the optical sensor the controller 44 can determine that the punch portion 24 has reached the home position. In some embodiments a magnetic sensor is provided for detecting the presence of a magnet carried by the anti-rotation bar 66 for generating output indicative that the punch portion 24 has reached the home position.

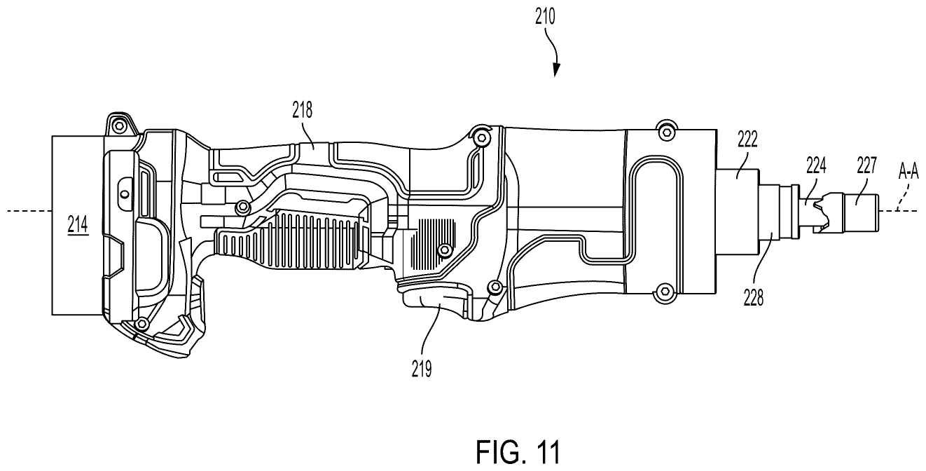

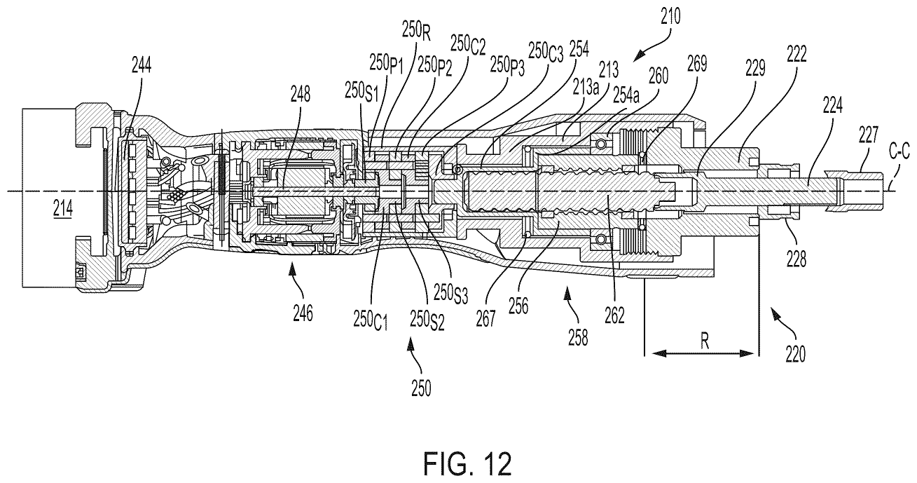

FIGS. 11 and 12 show another embodiment of the portable electric knockout punch 210, wherein corresponding features to the first embodiment described herein are labelled with like reference numerals increased by 200. The portable electric knockout punch 210 is an inline version wherein the battery attachment feature (and thus battery 214), the electric motor 246, the transmission 250, the ball screw mechanism 258 and the hole forming mechanism 220 are arranged in axial sequence one after the other.

Looking at FIG. 12 the motor output shaft 248 extends along the axis C-C and drives an input sun gear 250s1 of the first stage of the transmission 250. The input sun gear 250s1 meshes with a plurality of first stage planet gears 250p1 which mesh with a stationary outer ring gear 250R (which extends along the axis C-C) and are coupled to a first stage carrier 250c1. An axial extension of the first stage carrier 250c1 is the input sun gear 250s2 of the second stage of the transmission 250. The input sun gear 250s2 meshes with a plurality of second stage planet gears 250p2 which mesh with the stationary outer ring gear 250R and are coupled to a second stage carrier 250c2. An axial extension of the second stage carrier 250c2 is the input sun gear 250s3 of the third stage of the transmission 250. The input sun gear 250ss meshes with a plurality of third stage planet gears 250p3 which mesh with the stationary outer ring gear 250R and are coupled to a third stage carrier 250c3. An axial extension of the third stage carrier 250c3 cooperates with a drive sleeve 254 of the ball screw mechanism 258, wherein such features are rotationally locked such that rotation of the third stage carrier 250c3 rotatably drives the drive sleeve 254.

It will be appreciated that there is some design freedom in the transmission 250 between the motor output shaft 248 and the drive sleeve 254 of the ball screw mechanism 258. In particular the number of planetary gear stages, and its (or their) configuration, forming the transmission 250 depends on the required gear ratio to be achieved between the motor output shaft 248 and the drive sleeve 254 of the ball screw mechanism.

Similarly, as heretofore described in connection with the first embodiment the driving sleeve 254 is fixed to an input sleeve 256 due to a friction fit arrangement and an internal surface of the input sleeve 256 comprises a threaded surface for cooperating with a threaded surface of the threaded rod 262. Moreover, a plurality of balls, such as metal ball bearings, ride in the opposing threaded surfaces of the input sleeve 256 and threaded rod 262, thereby defining a ball screw arrangement 258.

A metal inner housing 213 supports the ball screw arrangement 258. A first axial bearing 267 is received between the internal surface of a first step portion 213a of the metal inner housing 213 and an external surface of a step portion 254a of the drive sleeve 254. A second axial bearing 269 is received between the internal surface of a second step portion of the metal inner housing 213 and an end surface of the input sleeve 256. The input sleeve 256 is thus axially supported between the second axial bearing 269 and an inner surface of the drive sleeve 254. Additionally the input sleeve 256 is supported in a radial direction by one or more bearings 260 which permit rotation of the input sleeve 256. In a radial direction the (or each) bearing 260 is (or are) located between the input sleeve 256 and the inner surface of the metal inner housing 213, whereby an outer race of the (or each) bearing 260 is friction fit with an inner surface of the metal inner housing 213 and an inner race of the (or each) bearing 260 is friction fit with the input sleeve 256. Looking at FIG. 12 the drive sleeve 254 is axially supported between the axial bearing 267 and the bearing 260, wherein the drive sleeve 254 extends though an opening defined by the axial bearing 267. The drive sleeve 254 rotates in use without touching the inner surface of the metal inner housing 213.

In use, torque from the electric motor 246 is transferred through the transmission 250 to the drive sleeve 254, whereby rotation thereof drives rotation of the input sleeve 256 for causing axial movement of the threaded rod 262. The threaded rod 262 is configured to move along the longitudinal axis C-C of the tool 210. The threaded rod 262 can move forwards or backwards along the axis C-C depending on the motor driving direction, whereby the punch portion 224 moves with the threaded rod 262 causing actuation of the hole forming mechanism 220.

With continued reference to FIG. 12 the rod-like punch portion 224 is fixed to the threaded rod 262 by a suitable connection between such features such as via a threaded connection or plug-and-socket type connection between such features. In particular the threaded rod 262 is rotatably and axially fixed to the rod-like punch portion 224. Since the punch portion 224 and support portion 222 of the bend mechanism 220 must permit movement relative to each other they are shaped and cooperate to enable axial movement between the punch portion 224 and support portion 222 but restrict rotational movement of the punch portion 224 and support portion 222 relative to each other; whereby in use the threaded rod 262 is able to move axially within the tool 210 but is restricted from rotating.

The support portion 222 defines an opening through which the punch portion 224 slides, namely an expanded section 229 of the punch portion 224 has an outer diameter substantially similar in shape and size to the inner diameter of the opening through the support portion 222. The range of axial movement of the punch portion 224 is defined by the length R of the opening through the support portion 222, whereby the expanded section 229 slides along the inner surface of such opening in use which provides that the risk of dirt entering the internal of the tool 210 is reduced and therefore that the reliability of the tool 210 is improved.

Designers are free to select a suitable way for the controller 244 to control operation of the motor 246 in use to implement a hole forming operation. In other words designers are free to select a suitable way for the controller 244 to determine when the hole forming mechanism 220 has been actuated sufficiently for a hole to be formed in the sheet metal being worked on, in other words designers are free to select a suitable way for the controller 244 to determine when the punch portion 224 has been moved far enough linearly for a hole to be punched in the sheet metal being worked on.

For example, in a starting configuration of the portable electric knockout punch 210 a die 228 and stamp 227 are loaded on the tool 210 on either side of some sheet metal as heretofore described. In this starting configuration the punch portion 224 is located in a home position, which is a predetermined starting position along the longitudinal axis C-C relative to the support portion 222. Upon the controller 244 determining that a trigger 219 of the tool 210 is actuated the controller 244 causes the electric motor 246 to rotate in a forward rotational direction for causing the punch portion 224 to be linearly moved along the longitudinal axis C-C towards the support portion 222 whereby a hole is punched in the sheet metal. In some embodiments users are required to manually judge when the stamp 227 has punched through the sheet metal and thus are required to release the trigger when a positive determination is made, wherein upon the controller 244 detecting that the trigger 219 is released it causes the motor 246 to drive in a reverse direction for causing the punch portion 224 to be returned to its home position.

As a safety mechanism a mechanical switch may be provided within the power tool 210 for causing a reset operation upon the threaded rod 262 becoming retracted into the tool 210 by a predetermined amount. During a hole forming stage of operation the threaded rod 262 is retracted into the tool 210. If the user does not release the trigger eventually the threaded rod 262 (or a feature provided thereon) will engage a mechanical switch, whereby upon the controller 244 detecting that the mechanical switch is activated it causes the motor 246 to reverse direction and returns the punch portion 224 to the home position; a user must then release the trigger before a subsequent hole forming operation can be implemented. In some embodiments instead of a mechanical switch an optical sensor can be used for detecting the presence of the threaded rod 262 for initiating a reset operation. Furthermore, in some embodiments a magnetic sensor is provided for detecting the presence of a magnet carried by the threaded rod 262 for initiating a reset operation.

Alternatively in some embodiments the controller 244 is configured to receive user input via a user interface of the tool 210 which is indicative of the thickness of the sheet metal being worked on, wherein based on this user input the controller 244 determines the extent to which the punch portion 224 should be retracted upon actuating the trigger 219. During a hole forming operation, while the trigger 219 remains actuated the controller 244 will cause enough movement of the punch portion 224 for punching a hole in the sheet metal being worked on and then will reverse motor direction and return the punch portion 224 to the home position, whereby the trigger must be released before a subsequent bending operation can be performed. At any time during a bending operation if the trigger is released the controller 244 will cause reverse movement of the motor 246 and will return the punch portion 224 to the home position.

Moreover, designers are free to select a suitable way for the controller 244 to control operation of the motor 246 to implement a reset operation. In other words designers are free to select a suitable way for the controller 244 to determine when the punch portion 224 has returned to the home position at which point in time reverse movement of the punch portion 224 is ceased. For example a mechanical switch may be provided within the tool 210. Following a hole forming operation, upon initiation of reverse movement of the motor 246 for causing a reset operation, the controller 244 is configured to detect output from the mechanical switch indicative that threaded rod 262 (or a feature provided thereon) actuates the mechanical switch, thereby indicating that the punch portion 224 has returned to the home position. Alternatively an optical sensor may be provided within the tool 210 which generates output based on the presence or absence of the threaded rod 262 wherein based on output from the optical sensor the controller 244 can determine that the punch portion 224 has reached the home position. In some embodiments a magnetic sensor is provided for detecting the presence of a magnet carried by the threaded rod 262 for generating output indicative that the punch portion 224 has reached the home position.

For the avoidance of doubt the portable electric knockout punch 10, 210 of either embodiment can be used with a range of dies 28 and stamps 27 configured to form holes in sheet metal of a range of different sizes. Accordingly, if a small hole is required to be formed in sheet metal then an appropriate die 28 and corresponding stamp 27 are removably mounted on the portable electric knockout punch 10, 210 whereas if a bigger hole is required to be formed in sheet metal then a different, appropriately configured, die 28 and corresponding stamp 27 are removably mounted on the portable electric knockout punch 10, 210.

It will be appreciated that whilst various aspects and embodiments have heretofore been described the scope of the present invention is not limited thereto and instead extends to encompass all arrangements, and modifications and alterations thereto, which fall within the spirit and scope of the appended claims.

In some embodiments the angle between the first longitudinal axis A-A and the second longitudinal axis B-B may not be 90 degrees and instead may range between 45 degrees to 145 degrees, which is achievable by adjusting the angle at which the input pinion 52 and the bevel gear 53 of the bevel gear arrangement 49 mesh.

In some embodiments the motor 46 is only partially received within the handle 18.

In some embodiments at least one planetary gear stage of the transmission 50 is received in the handle 18.

In some embodiments the motor 46 and the transmission 50 are received in the handle 18.

It has already been mentioned that by providing the motor 40 within the handle 18 leaves more space available within the tool housing 12 above the handle 18, whereby there is more freedom to position features of the tool 10 in positions which improve weight distribution of internal features of the tool 10. By providing the motor 46 only partially within the handle 18 achieves such advantage to a lesser extent. By providing the motor 46 and also at least part of the transmission 50 within the handle 18 achieves such advantage to a greater extent. By providing the motor 46 and also the transmission 50 within the handle 18 achieves such advantage to a fuller extent.

In some examples the battery 14, 214 is removable from the tool 10, 210 or alternatively the battery 14, 214 is integral to the tool 10, 210. Alternatively, or additionally, the tool 10, 210 may be configured to receive electric power from a mains power supply.

As shown in FIGS. 8 and 12, the driving sleeve 54, 254 and input sleeve 56, 256 are fixed to each other due to a friction fit arrangement. Alternatively, the driving sleeve 54, 254 and input sleeve 56, 256 can be fixed via an interlocking arrangement such as a spline fit arrangement or other male and female interlocking-type arrangement.

The electric motor 46, 246 has been described as being a brushless motor and the controller 44, 244 cooperates with the brushless motor (in particular with its control electronics) in order to control the brushless motor. In other embodiments however the motor 46, 246 may be a brushed motor having a motor output shaft driven by a stator and having at least one magnet on the motor output shaft. It is here mentioned that in battery operated embodiments the motor 46, 246 is configured to operate using DC current, whereas in mains operated embodiments the motor is configured to operate using AC current.

In some embodiments the tool 10, 210 may have a roller screw mechanism (sometimes known as a planetary roller screw mechanism) instead of a ball screw mechanism 58, 258 for converting torque into linear force. A person skilled in the art will appreciate that this can be achieved by rotationally fixing the driving sleeve 54, 254 to an input sleeve of the roller screw mechanism; wherein a set of rollers (sometimes called planetary rollers) are provided between the internal surface of the input sleeve and an external surface of the threaded rod 62, 262. When the driving sleeve 54, 254 is caused to rotate it drives rotation of the input sleeve of the roller screw mechanism and thus via the rollers causes linear movement of the threaded rod 62, 262 and thus causes actuation of the hole forming mechanism 20, 220.

Although the connection between the threaded rod 62, 262 and the punch portion 24, 224 has been described as being a threaded connection, it will be appreciated that such a connector or connection means is not limiting and that such features could alternatively be coupled in other ways for example via a plug and socket-type attachment wherein a male connection part of either the threaded rod 62, 262 and the punch portion 24, 224 cooperates with a female connection part of the other of the threaded rod 62, 262 and the punch portion 24, 224.

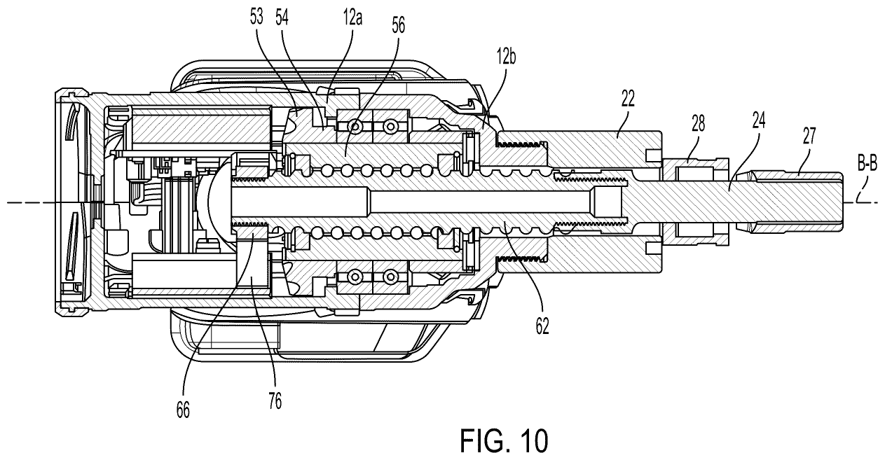

The embodiment of the tool 10 described in connection with FIGS. 8 to 10 has an anti-rotation bar 66 for preventing rotation of the threaded rod 62. On the contrary the embodiment of the tool 210 described in connection with FIGS. 11 and 12 omits an anti-rotation bar whereas rotation of the threaded rod 262 is prevented by configuring the punch portion 224 and support portion 222 of the hole forming mechanism 220 so as to permit relative axial movement between the punch portion 224 and support portion 222 but restrict rotational movement of the punch portion 224 and support portion 222 relative to each other; whereby in use the threaded rod 262 is able to move axially within the tool 210 but is restricted from rotating. It will be appreciated that in some embodiments the tool 10 can omit an anti-rotation bar 66 whereas rotation of the threaded rod 62 is prevented by cooperation between the punch portion 24 and support portion 22 of the hole forming mechanism 20 which permit relative axial movement but not relative rotational movement; wherein operation of the tool 10 can be controlled in a manner similar to that heretofore described in connection with the tool 210. Furthermore, it will be appreciated that in some embodiments the tool 210 can have an anti-rotation bar for preventing rotation of the threaded rod 262; wherein operation of the tool 210 can be controlled in a manner similar to that heretofore described in connection with the tool 10.

What is claimed is:

1. A portable electric knockout punch for forming a hole in sheet metal comprising an electric motor having a motor output shaft, a hole forming work member having a support portion for cooperating with a die and a punch portion for cooperating with a stamp and which is operatively coupled to the motor output shaft via a transmission of the tool which in use causes linear relative movement between the punch portion and the support portion for forming a hole in sheet metal in use, the transmission comprising a conversion mechanism for converting torque into a linear force for causing said linear relative movement between the punch portion and the support portion.

2. The portable electric knockout punch of claim 1, wherein the conversion mechanism is a ball screw mechanism or a roller screw mechanism.

3. The portable electric knockout punch of claim 1, wherein the electric motor is arranged at least partially within the handle of the portable electric knockout punch such that the motor output shaft extends along a first axis extending along the length of the handle; the portable electric knockout punch is configured such that said relative movement of the punch portion and the support portion occurs linearly along a second axis; and the transmission comprises a bevel gear arrangement for redirecting torque flowing along the first axis and input to the bevel gear arrangement in use so that torque output from the bevel gear arrangement flows along the second axis and into the conversion mechanism.

4. The portable electric knockout punch of claim 3, wherein the angle between the first axis and the second axis is between 45 degrees to 145 degrees, optionally 90 degrees.

5. The portable electric knockout punch of claim 3, wherein the electric motor is located entirely within the handle of the portable electric knockout punch.

6. The portable electric knockout punch of claim 3, wherein the transmission comprises at least one planetary gear stage for transferring torque from the electric motor along the first axis in use, optionally wherein the at least one planetary gear stage is at least partially located within the handle of the portable electric knockout punch, further optionally wherein the at least one planetary gear stage is entirely located within the handle of the portable electric knockout punch.

7. The portable electric knockout punch of claim 3, further comprising a battery attachment portion on the handle so that a notional line extending between the battery attachment portion and the motor output shaft extends along the first axis.

8. The portable electric knockout punch of claim 1, wherein the electric motor, the transmission and the hole forming mechanism are arranged along an axis in axial sequence one after the other.

9. The portable electric knockout punch of claim 8, further comprising a battery attachment portion located on the same said axis.

10. The portable electric knockout punch of claim 1, further including at least one magnet for holding the die in engagement with the support portion.

11. The portable electric knockout punch of claim 1, wherein the punch portion has a threaded part for engaging with a threaded opening of the stamp.

12. The portable electric knockout punch of claim 1, wherein the electric motor is a brushless DC motor.
